(19) United States
(12) Patent Application Publication
(10) Pub. No.: US 2010/0103642 A1
(43) Pub. Date: Apr. 29, 2010

(54) Adjustable Focus Light Globe Apparatus and Methods

(76) Inventor: Sergio Alejandro Ortiz-Gavin, Los Angeles, CA (US)

Correspondence Address: EDWARD C. SCHEWE, 1600 Rosecrans Avenue, Fourth Floor, MANHATTAN BEACH, CA, 90266, US

(21) Appl. No.: 12/605,812

(22) Filed: Oct. 26, 2009

Related U.S. Application Data
(60) Provisional application No. 61/108,537, filed on Oct. 26, 2008.

(51) Int. Cl. G03B 15/02

(52) U.S. Cl. 362/3

(57) ABSTRACT

A light globe apparatus and methods to produce diffused light with a substantially translucent skin portion and with a substantially reflective skin portion. The apparatus and methods utilize an adjustable globe shape that substantially envelopes a photographic light to produce a desirable highly dynamic modulated adjustable focus diffused light source for still and motion picture photography.

### RELATED APPLICATION DATA

This application claims the benefit of U.S. Provisional Patent Application Ser. No. 61/108,537 filed on Oct. 26, 2008.

### BACKGROUND OF THE INVENTION

1. Field of the Invention

The invention relates to and adjustable focus light globe apparatus and methods to produce a highly dynamic modulated adjustable focus diffused light and particularly, apparatus and methods for producing a desirable light quality with adjustable focus diffused light for still and motion picture photography.

2. Description of the Related Art

A variety of lighting techniques to create diffused lighting have been used for still and motion picture photography. However, conventional systems are often unreliable and inefficient in a field that demands new and improved techniques. A need exists for improved and novel apparatus and methods that overcome the limitations in conventional lighting systems to reliably produce highly dynamic diffused light with modulated focusability for still and motion picture photography.

### SUMMARY OF THE INVENTION

A light globe apparatus and methods to produce a very desirable highly dynamic modulated adjustable focus diffused light source for still and motion picture photography. The invention includes a substantially translucent skin configured into a globe shape that surrounds or envelopes a photographic light source to produce diffused light. The globe shape and position are adjustable along the length of a focusing tube support to produce varying lighting effects as desired by professional photographers.

Further advantages and embodiments of the invention will be apparent to persons skilled in the art from the drawings and description set forth herein.

### BRIEF DESCRIPTION OF THE DRAWINGS

FIG. 1 is a perspective view of one embodiment of the invention illustrating the translucent skin.

FIG. 2 is a side elevation view of one embodiment of the invention illustrating a globe with a portion of the skin having a highly reflective interior surface skin that acts as a reflector directing light from the source in a desired direction focused into the diffusion and blocking light in the other direction with an opaque portion.

FIG. 3 is a side elevation view of one embodiment of the invention illustrating the globe supports adjustably mounted on a focus tube with a light source mounted to the support tube.

FIG. 4 is partial side view of one embodiment of the invention illustrating the adjustable brake incorporating a torsion spring partially caged by a machined recess that keeps the spring in line and parallel to the focus tube when features 24a and 24b on the torsion spring are squeezed together allowing the focus tube to fully adjust and illustrating the ring support for the globe supports.

### DETAILED DESCRIPTION OF EMBODIMENTS OF THE INVENTION

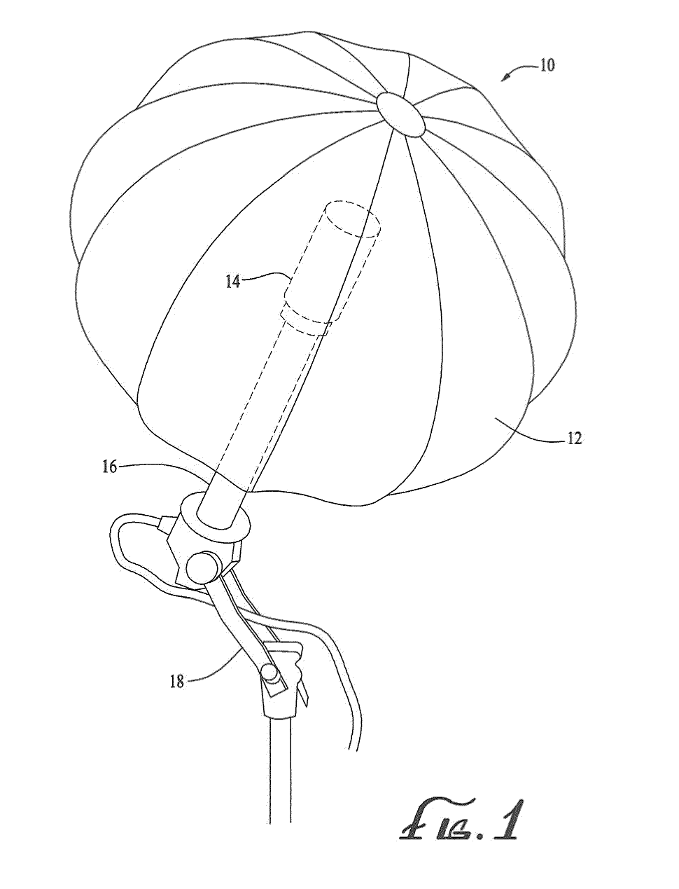

In FIG. 1 the light globe 10 is shown in one embodiment with the skin 12 configured into a globe shape surrounding a light source 14, shown in dashed lines. The light source 14 is attached to a focus tube support 16 shown partially in dashed lines which is secured to an electrical supply and external support 18.

The skin 12 is made from a translucent material well known to persons skilled in the art that allows light to pass through but diffuses the light produced thereby and/or from a highly reflective material to reflect light in the same way a parabolic reflector works as known to skilled persons.

The shape of the globe includes not only the substantially spherical configuration shown in FIG. 1, but includes other common shapes referred to as globes, and includes but is not limited to tear-drop shape, a pear shape and other shapes known to persons skilled in the art. The light source 14 includes flash tubes and photographic light sources known to persons skilled in the art for still and motion picture photography.

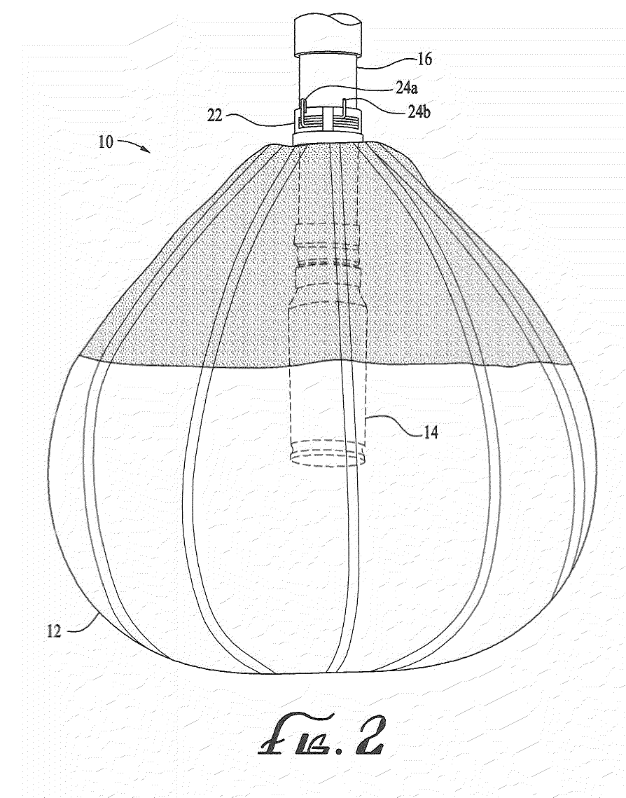

FIG. 2 illustrates one embodiment where the skin 12 of the light globe 10 includes a highly reflective portion (illustrated as the lower portion of the globe 10 in FIG. 2) or substantially opaque portion (illustrated as the upper portion in FIG. 2) for producing additional diffused lighting effects.

In other embodiments, torsion spring brake and housing 22 as illustrated in FIG. 2 is utilized to focus or adjust the position of the globe 10 on the tube support 16. The torsion spring brake and housing 22 is manually adjustable by squeezing the spring arms 24a and 24b to allow the brake 22 to be positioned on the tube support 16. Releasing the spring arms 24a and 24b secures the brake and housing 22 to the tube support 16.

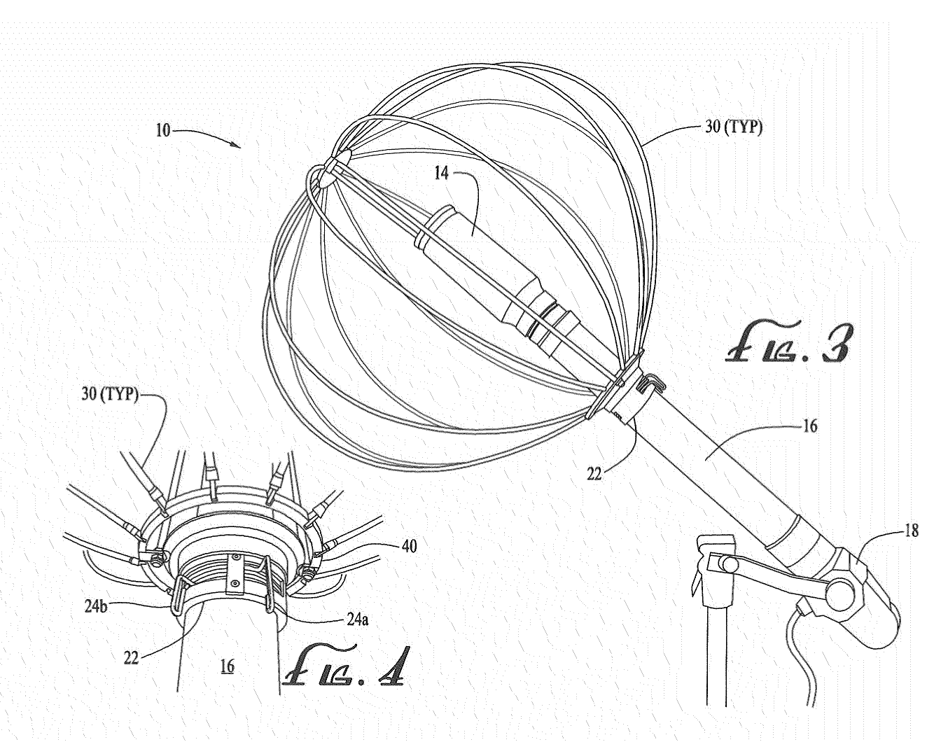

FIG. 3 illustrates an embodiment with the skin 12 removed to show the globe supports 30 and the relative position of the light source 14. The globe supports 30 are made from materials well known to persons skilled in the art and can include a metal, plastic or other composite materials.

By adjusting the position of the torsion spring brake and housing 22 along the focus tube 16 toward the light source 14, it will be understood that the configuration of the globe supports 30 will change which would also changes the shape of the light globe 10 with the skin 12 placed onto the globe supports 30.

FIG. 4 is a close up view of one embodiment with the ring support 40 that supports the globe supports 30 at one end that is secured adjacent to the spring-loaded brake and housing 22 positioned on the tube support 16.

While the present invention has been described with regards to particular embodiments, it is recognized that additional variations of the present invention may be devised without departing from the inventive concepts in the claims and the invention includes the full breadth and scope of the claims including all equivalents.

What is claimed is:

1. An apparatus for producing diffused light comprising a substantially translucent skin portion and a substantially reflective skin portion with a plurality of globe supports, the globe supports adapted to adjustably configure the skin into a globe shape to substantially surround a photographic light source to generate diffused light.

2. The apparatus of claim 1 where the light source comprises a constant light source or a flash light source.

3. The apparatus of claim 1 where the globe supports are adjustably mounted to a focus tube support.

4. The apparatus of claim 3 where the globe supports are adjustably mounted to the tube support by a torsion spring brake and housing.

5. A method for producing diffused light for photography comprising the steps of arranging a plurality of globe supports to configure a substantially translucent skin portion and a substantially reflective skin portion into a globe configuration that substantially surrounds a photographic light source; and activating the light source to produce diffused light.

6. The method of claim 5 further comprising the step of adjustably mounting the globe supports by a torsion spring brake to a tube support attached to the photographic light source.
